(19) United States
(12) Patent Application Publication
(10) Pub. No.: US 2019/0318359 A1
(43) Pub. Date: Oct. 17, 2019

(54) METHOD AND SYSTEM FOR FRAUD PREVENTION VIA BLOCKCHAIN

(71) Applicant: MASTERCARD INTERNATIONAL INCORPORATED, Purchase, NY (US)

(72) Inventor: Ankur ARORA, New Delhi (IN)

(73) Assignee: MASTERCARD INTERNATIONAL INCORPORATED, Purchase, NY (US)

(21) Appl. No.: 15/955,021

(22) Filed: Apr. 17, 2018

(51) Int. Cl. G06Q 20/40; G06Q 20/20

(52) U.S. Cl. CPC G06Q 20/4016; G06Q 20/20

(57) ABSTRACT

A method for determining fraud for a transaction via blockchain includes: receiving blockchain data for a blockchain including a plurality of blocks, each block being comprised of a block header and data values, each data value corresponding to a declined payment transaction and including an account identifier, timestamp, and point of sale identifier; receiving payment credentials associated with a transaction account, the payment credentials including an account number; identifying one or more data values where the account identifier is the account number; determining a decline of a payment transaction involving the transaction account based on transaction data for the payment transaction and data included in the one or more data values; and transmitting a timestamp, the account number, and a device identifier to a node associated with the blockchain.

### FIELD

The present disclosure relates to the prevention of fraud in a payment transaction via blockchain, specifically the use of a blockchain to track details regarding declined transactions for a transaction account and use thereof in preventing fraud in future transactions on the same account.

### BACKGROUND

The use of a transaction account to fund a payment transaction may be declined for any number of reasons, such as insufficient funding, a compromised merchant system, or suspected fraud by the use of the transaction account. When a payment instrument for a transaction account is stolen or otherwise acquired by a fraudulent party, that party may attempt to use the payment instrument for a number of transactions in order to defraud the account holder. However, many payment instruments and transaction accounts require the use of authentication methods, such as the entering of a personal identification number (PIN), in order to prevent such authorized usage. If the fraudulent party attempts to transact with the payment instrument and enters the wrong authentication data, the transaction may be declined.

However, the fraudulent party may be free to continue to attempt to use the payment instrument, trying other PINs or other authentication data until finally successful. Thus, such authentication methods may only be suitable for protecting the transaction account temporarily. In many cases, an issuing institution associated with the transaction account may inquire with the account holder about the attempted usage of the payment instrument when multiple declines occur, to determine if the declines are genuine (e.g., the account holder mistyped or forgot their PIN, let someone borrow their card with the borrower forgetting the PIN, etc.), or if a fraudulent party is attempting usage. If the account holder indicates that attempted fraud is occurring, the payment instrument may be cancelled so any attempted transaction using the payment instrument is automatically declined. However, this is a time consuming process that requires positive participation by both the issuing institution and the account holder, during which time the fraudulent party may be able to break the authentication and steal thousands of dollars from the issuing institution and/or account holder. Computationally, this may create a large burden on the issuers systems, particularly if there has be a data breach that resulting in a large number of compromised card accounts.

Thus, there is a need for a technological solution where attempted fraudulent usage of a payment instrument may be detected without requiring positive participation by an issuing institution or account holder to increase account security while simultaneously decreasing resource expenditure in payment systems.

### SUMMARY

The present disclosure provides a description of systems and methods for determining fraud for payment transactions via the use of a blockchain. A blockchain provides for a publicly accessible data set that can enable any entity or system involved in a payment transaction to determine if fraud is occurring, for the prevention of an attempted payment transaction in such events. The blockchain stores data regarding past declines of a payment transaction, where any potentially sensitive account information is not stored on the blockchain, while the blockchain still contains suitable data regarding the declines. Any entity or system involved in the processing of a transaction, including the point of sale system, can access the blockchain to identify past declines for a transaction account and use such data to determine if an attempted transaction should be declined out of concern for fraud. As a result, an attempted fraudulent payment transaction can be stopped before it occurs and without requiring any positive participation by an account holder or even an issuing institution, including the transaction being stopped before even being submitted to a payment network for processing. As such, fraud can be detected faster and using significantly less resources, which frees up resources for other entities involved in payment transactions to improve additional processes, while at the same time increasing account security by detecting fraud sooner and without requiring participation by the account holder.

A method for determining fraud for a transaction via blockchain includes: receiving, by a receiving device of a point of sale device, blockchain data for a blockchain, wherein the blockchain data is comprised of a plurality of blocks, each block being comprised of at least a block header and one or more data values, each data value corresponding to a declined payment transaction and including at least an account identifier, timestamp, and point of sale identifier; receiving, by the receiving device of the point of sale device, payment credentials associated with a transaction account, wherein the payment credentials include at least a transaction account number; executing, by a querying module of the point of sale device, a query on the blockchain data to identify one or more data values where the included account identifier corresponds to the transaction account number; determining, by a determination module of the point of sale device, a decline of a payment transaction involving the transaction account based on at least transaction data for the payment transaction and data included in the identified one or more data values; and electronically transmitting, by a transmitting device of the point of sale device, at least a timestamp, the transaction account number, and a device identifier associated with the point of sale device to a node associated with the blockchain.

A system for determining fraud for a transaction via blockchain includes: a receiving device of a point of sale device configured to receive blockchain data for a blockchain, wherein the blockchain data is comprised of a plurality of blocks, each block being comprised of at least a block header and one or more data values, each data value corresponding to a declined payment transaction and including at least an account identifier, timestamp, and point of sale identifier, and receive payment credentials associated with a transaction account, wherein the payment credentials include at least a transaction account number; a querying module of the point of sale device configured to execute a query on the blockchain data to identify one or more data values where the included account identifier corresponds to the transaction account number; a determination module of the point of sale device configured to determine a decline of a payment transaction involving the transaction account based on at least transaction data for the payment transaction and data included in the identified one or more data values; and a transmitting device of the point of sale device configured to electronically transmit at least a timestamp, the transaction account number, and a device identifier associated with the point of sale device to a node associated with the blockchain.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for determining fraud via use of a blockchain in accordance with exemplary embodiments.

FIG. 2 is a block diagram illustrating the point of sale device of the system of FIG. 1 for the determination of fraud in a payment transaction using a blockchain in accordance with exemplary embodiments.

FIG. 3 is a flow diagram illustrating a process for determining fraud in a payment transaction using a blockchain by the point of sale device of FIG. 2 in accordance with exemplary embodiments.

FIG. 4 is a flow chart illustrating an exemplary method for determining fraud for a transaction via blockchain in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require any special knowledge in offered products. In some embodiments, an entity involved in a single transaction may be considered a merchant. In some instances, as used herein, the term “merchant” may refer to an apparatus or device of a merchant entity.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

Point of Sale—A computing device or computing system configured to receive interaction with a user (e.g., a consumer, employee, etc.) for entering in transaction data, payment data, and/or other suitable types of data for the purchase of and/or payment for goods and/or services. The point of sale may be a physical device (e.g., a cash register, kiosk, desktop computer, smart phone, tablet computer, etc.) in a physical location that a customer visits as part of the transaction, such as in a “brick and mortar” store, or may be virtual in e-commerce environments, such as online retailers receiving communications from customers over a network such as the Internet. In instances where the point of sale may be virtual, the computing device operated by the user to initiate the transaction or the computing system that receives data as a result of the transaction may be considered the point of sale, as applicable.

Blockchain—A public ledger of all transactions of a blockchain-based currency. One or more computing devices may comprise a blockchain network, which may be configured to process and record transactions as part of a block in the blockchain. Once a block is completed, the block is added to the blockchain and the transaction record thereby updated. In many instances, the blockchain may be a ledger of transactions in chronological order, or may be presented in any other order that may be suitable for use by the blockchain network. In some configurations, transactions recorded in the blockchain may include a destination address and a currency amount, such that the blockchain records how much currency is attributable to a specific address. In some instances, the transactions are financial and others not financial, or might include additional or different information, such as a source address, timestamp, etc. In some embodiments, a blockchain may also or alternatively include nearly any type of data as a form of transaction that is or needs to be placed in a distributed database that maintains a continuously growing list of data records hardened against tampering and revision, even by its operators, and may be confirmed and validated by the blockchain network through proof of work and/or any other suitable verification techniques associated therewith. In some cases, data regarding a given transaction may further include additional data that is not directly part of the transaction appended to transaction data. In some instances, the inclusion of such data in a blockchain may constitute a transaction. In such instances, a blockchain may not be directly associated with a specific digital, virtual, fiat, or other type of currency.

### System for the Fraud Determinations Using a Blockchain

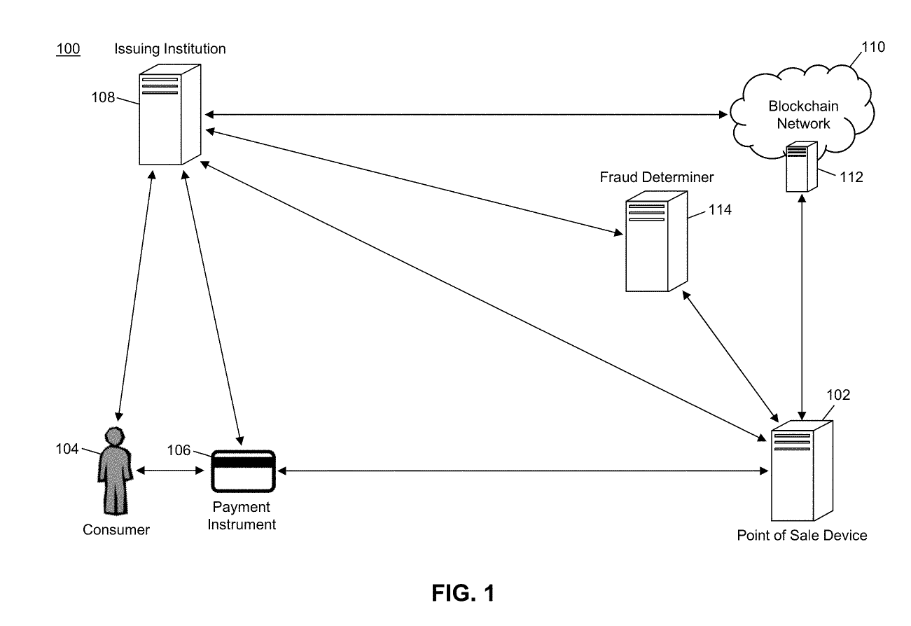

FIG. 1 illustrates a system 100 for the determination of fraud in a payment transaction based on past declined payment transactions using the same transaction account as identified via use of a blockchain.

The system 100 may include a point of sale device 102. The point of sale device 102 may be part of a point of sale system that is used to initiate the processing of payment transactions on behalf of a merchant. The point of sale device 102, discussed in more detail below, may be configured to decline payment transactions due to suspected fraud based on past declined payment transactions for a transaction account that is being used to fund the payment transaction, which may be identified via the use of a blockchain. In the system 100, a consumer 104 may possess a payment instrument 106 that they present to the point of sale device 102 for use in funding a proposed payment transaction. The payment instrument 106 may be a payment card, check, virtual card, or other suitable type of instrument that is issued by an issuing institution 108 for a transaction account that is used to convey payment credentials for that transaction account to a point of sale device 102 for use in the processing of a payment transaction. For instance, the payment instrument 106 may be a credit card with a magnetic stripe or integrated circuit chip that stored payment credentials therein that are electronically transmitted to the point of sale device 102 during a proposed payment transaction. The issuing institution 108 may be any type of entity, such as a financial institution (e.g., an issuing bank), that is configured to issue transaction accounts for use in funding payment transactions and payment instruments 106 associated therewith.

In a traditional payment transaction, the payment instrument 106 is presented to the point of sale device 102, which reads the payment credentials included therein. The point of sale device 102 then submits transaction details for a proposed payment transaction, including the payment credentials, to a payment network, either directly or via one or more intermediate entities (e.g., acquiring institutions, gateway processors, etc.), where the payment network processes the payment transaction using traditional methods and systems. In many traditional payment transactions, authentication data may be captured from the consumer 104 that are included in the transaction details that are submitted to the payment network. As part of the traditional processing, the issuing institution 108 may be provided with a transaction message including the transaction details, where the issuing institution 108 may identify the transaction account that would be used to fund the payment transaction based on the payment credentials and may determine if the payment transaction should be approved or denied, such as based on the supplied authentication data, an account balance or credit limit, etc. The point of sale device 102 may be informed of the approval or denial, and may finalize the payment transaction with the consumer 104 accordingly.

In the system 100, the point of sale device 102 may be configured to determine if the payment transaction should be declined due to an unacceptable likelihood of fraud due to past transaction declines before any transaction details are submitted to a payment network for processing. The system 100 may include a blockchain network 110. The blockchain network 110 may be associated with a blockchain that may be used to store data regarding declined payment transactions associated with a transaction account for use by the point of sale device 102 for determining if a payment transaction should be declined prior to formal processing by a payment network. The blockchain network 110 may be comprised of a plurality of nodes 112, where each node is configured to store the blockchain, generate new blocks, validate blocks, and serve as a point of communication with outside systems, including the point of sale device 102 and issuing institution 108. When a payment transaction is declined, such as by the point of sale device 102 using the methods discussed herein or the issuing institution 108 during traditional processing, transaction data for the declined payment transaction may be electronically transmitted to a node 112 in the blockchain network 110 for addition to the associated blockchain.

A blockchain may be comprised of a plurality of blocks, where each block includes at least a block header and one or more data values. The data values may each be related to a declined payment transaction and include data associated therewith, including at least an account identifier, timestamp, and a point of sale identifier. The account identifier may be a unique value associated with a transaction account for use in identification thereof, such as a primary account number, identification number, or other suitable. In an exemplary embodiment, the account identifier may be a value other than a primary account number or other type of payment credential that may still be used for identification of the transaction account without compromise of any account details. For instance, the account identifier may be a hashed primary account number. The timestamp may be a time at which the payment transaction was attempted and/or declined. The point of sale identifier may be a unique value associated with the point of sale device 102 that was used in the attempted payment transaction. The point of sale identifier may be any type of suitable value, such as an identification number, media access control address, internet protocol address, registration number, serial number, etc. In some cases, a data value may include any additional transaction data associated with the declined payment transaction that may be useful in performing the functions discussed herein, such as a geographic location, transaction amount, merchant identifier, currency type, reason code, etc.

Each block header may include at least a timestamp, a block reference value, and a data reference value. The timestamp may be a time at which the respective block or block header was generated. The block reference value may be a reference to the previous block (e.g., determined by timestamp) added to the blockchain. In an exemplary embodiment, the block reference value may be a hash value generated via the application of one or more hashing algorithms to the block header of the previous block in the blockchain. The data reference value may be a reference to the one or more data values included in the respective block. In an exemplary embodiment, the data reference value may be a hash value generated via the application of one or more hashing algorithms to the one or more data values included in the respective block. In some cases, the data reference value may be the root of a Merkle tree generated using the one or more data values.

The use of the reference values may provide for immutability of the blockchain. In order to modify a data value on the blockchain, that block's data reference value must be modified accordingly, which would subsequently require modification to the subsequent block's block reference value due to the change in the block header, which would thus require modification to the next subsequent block's block reference value, and so on, propagating through the entire remainder of the blockchain. As each node 112 in the blockchain network 110 separately stores a copy of the blockchain and is in constant communication with one another to validate and add new blocks, such modifications must occur in every single node 112 in the blockchain network 110 and before a new block can be added. As a result, modification to any data in the blockchain is exceedingly difficult and, in many cases, due to processing and communication limitations, functionally impossible. Thus, the data stored in the blockchain regarding declined payment transactions may be considered to be accurate as it may not be tampered with or otherwise modified.

The blockchain may be accessible to the point of sale device 102. When the consumer 104 presents the payment instrument 106 to the point of sale device 102 for a proposed payment transaction, the point of sale device 102 may read the payment credentials included therein from the payment instrument 106. The payment credentials may include an account identifier or other data that may be used by the point of sale device 102 in identifying an account identifier (e.g., by hashing a primary account number read from the payment instrument 106). The point of sale device 102 may receive or otherwise access the blockchain from a node 112 in the blockchain network 110 and identify declined payment transactions attempted using the transaction account associated with the payment instrument 106 using the account identifier. The point of sale device 102 may then determine if the proposed payment transaction should be declined or submitted for processing based on the history of declined payment transactions.

For example, the blockchain data may indicate that the payment instrument 106 was used in several attempted payment transactions earlier in the same day (e.g., based on the timestamps) at different merchants (e.g., based on merchant identifiers) in the same geographic area (e.g., based on geographic locations), indicating that the consumer 104 is an unauthorized user that is attempting to make use of a stolen payment instrument 106. In another example, the blockchain data may indicate that the payment instrument 106 has been used in several attempted payment transactions at the same merchant of the point of sale device 102 repeated in a short period of time, indicating that the consumer 104 is attempting unauthorized use of the payment instrument 106 without having the proper authentication data. The exact number of declines that would indicate fraud could be just to total in each category (e.g., 5 declines due to the wrong PIN in a given day, or 4 declines for the wrong PIN at different merchants in two days, or 3 declines at one merchant coupled with two declines at two additional merchants for any reason, or any number of patterns that implicitly or empirically suggest the degree of likelihood of fraud to provide a fraud score (e.g., 51% likely to be fraud, or on a scale of 1 to 10, or a complex multifactor score, as but a few examples). These thresholds can be in the form of an algorithm stored locally or centrally, and both or either the algorithms and thresholds for declining can be determined for each POS, POS in a geographic region or by merchant code, or by issuer or a third party, as circumstances may dictate. In a different example, the blockchain data may indicate that the payment transaction has not been declined in a considerable amount of time, and that the last decline was due to insufficient balance (e.g., as opposed to failed authentication), indicating that the consumer 104 is likely an authorized user. The point of sale device 102 may then proceed with the payment transaction accordingly based on a fraud determination using the history of declined transactions, where the payment transaction may be immediately declined for fraud or the transaction details submitted to a payment network for processing using traditional methods.

In some embodiments, the point of sale device 102 may have fraud algorithms stored therein for use in determining if a payment transaction should be declined or attempted based on the available history of declined payment transactions. In some cases, the algorithms may be used to generate a fraud score for the payment transaction based on the declined payment transactions and, in some cases, also the transaction details for the proposed payment transaction, where the proposed payment transaction may be declined if the fraud score exceeds a scoring threshold indicative of a high likelihood of fraud. In other embodiments, issuing institutions 108 may provide fraud algorithms to the point of sale device 102, where the point of sale device 102 may use a fraud algorithm associated with the issuing institution 108 that issued the payment instrument 106 (e.g., as identified via the account identifier or other payment credentials) to determine if the proposed payment transaction should be declined. For instance, each issuing institution 108 may have its own criteria to determine if a payment transaction should be immediately declined or submitted for processing such that the issuing institution 108 may provide the final fraud determination.

In some embodiments, the point of sale device 102 may be configured to provide transaction details for the proposed payment transaction to an outside entity for use in determining if the payment transaction is to be declined. For instance, in one example, the point of sale device 102 may provide the proposed transaction details to the issuing institution 108. The issuing institution 108 may then access the blockchain via a node 112 in the blockchain network 110 to identify the history of declined transactions, may make a determination as to the likelihood of fraud of the proposed payment transaction based thereon, and provide the determination to the point of sale device 102 for use in proceeding with the payment transaction. In some cases, the point of sale device 102 may provide the declined transaction history, obtained from the blockchain, to the issuing institution 108.

In some embodiments, the system 100 may include a fraud determiner 114. The fraud determiner 114 may be a third party entity that is configured to provide fraud determinations based on declined transaction history for a transaction account on behalf of the issuing institution 108 and/or point of sale device 102. For instance, the issuing institution 108 may provide its fraud algorithms to the fraud determiner 114 as an authorized third party, where the point of sale device 102 may provide the proposed transaction details (e.g., and historical declined transaction data retrieved from the blockchain, if applicable) to the fraud determiner 114, that may provide the point of sale device 102 with the determination if the transaction is to be processed or declined. In some cases, the issuing institution 108 and/or fraud determiner 114 may generate a fraud score that is returned to the point of sale device 102, where the point of sale device 102 may use the fraud score to determine if the payment transaction should be declined or processed.

The methods and systems discussed herein enable a point of sale device 102 to decline a payment transaction when fraud is suspected based on a history of declined payment transactions without requiring submission of transaction details to a payment network for processing. As a result, the payment transaction may be declined in significantly less time and in a manner that reduces the processing load of payment networks and issuing institutions 108 and reduces the number of communications that go across payment networks, reducing bandwidth demands and providing more capability for other communications. The use of a blockchain to store the declined transaction history may enable point of sale devices 102 to freely access declined transaction history without requiring participation by issuing institutions 108 and where the data is immutable and cannot be tampered with by a nefarious actor. As a result, point of sale devices 102 in the system 100 may use information that is guaranteed to be reliable and accurate when making assessments. In cases where an issuing institution 108 provides algorithms or other information to the point of sale device 102, the custom criteria used by an issuing institution 108 for fraud determinations may still be used in declining payment transactions proposed for funding by transaction accounts issued by that issuing institution 108 without requiring participation by the issuing institution in that particular transaction. Thus, the methods and systems discussed herein can significantly increase processing times and efficiency while reducing the participation required by issuing institutions 108 while still maintaining a high level of account security and protection from fraud.

### Point of Sale Device

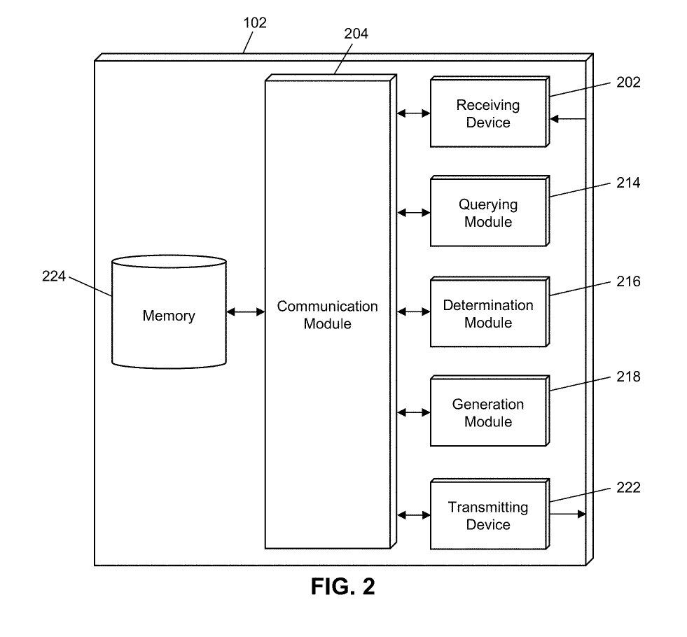

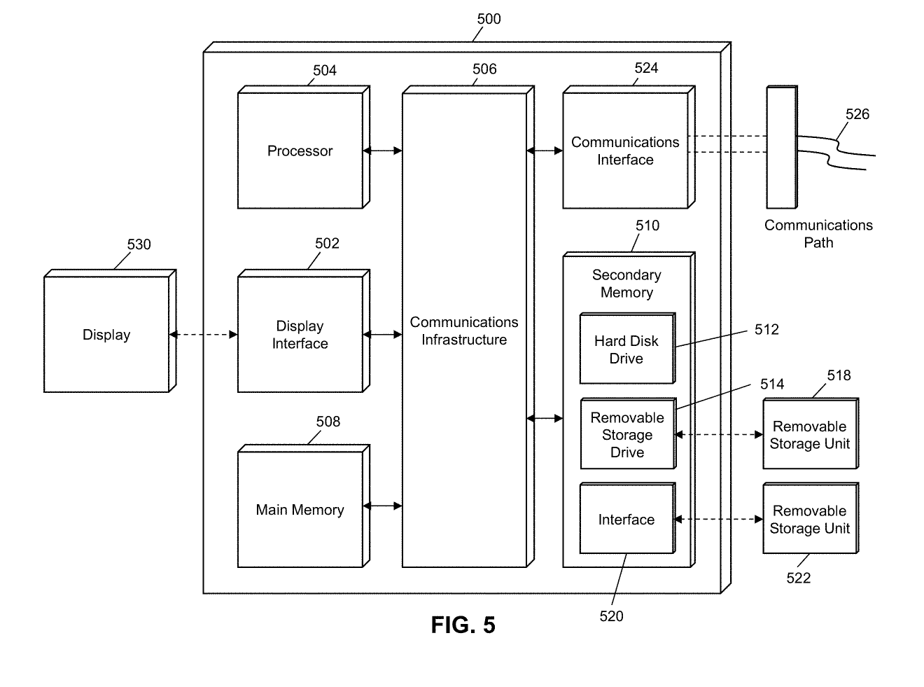

FIG. 2 illustrates an embodiment of a point of sale device 102 in the system 100. It will be apparent to persons having skill in the relevant art that the embodiment of the point of sale device 102 illustrated in FIG. 2 is provided as illustration only and may not be exhaustive to all possible configurations of the point of sale device 102 suitable for performing the functions as discussed herein. For example, the computer system 500 illustrated in FIG. 5 and discussed in more detail below may be a suitable configuration of the point of sale device 102.

The point of sale device 102 may include a receiving device 202. The receiving device 202 may be configured to receive data over one or more networks via one or more network protocols. In some instances, the receiving device 202 may be configured to receive data from payment instruments 106, issuing institutions 108, nodes 112, fraud determiners 114, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by payment instruments 106 or otherwise read therefrom that are superimposed or otherwise encoded with payment credentials, including at least an account identifier or data that may be used by the point of sale device 102 in generating or otherwise obtaining an account identifier associated with a transaction account. The receiving device 202 may be configured to receive data signals electronically transmitted by issuing institutions 108, which may be superimposed or otherwise encoded with fraud algorithms, fraud scores, or fraud determinations, as applicable as discussed herein. The receiving device 202 may also be configured to receive data signals electronically transmitted by fraud determiners 114 that are superimposed or otherwise encoded with fraud determinations and/or fraud scores for use by the point of sale device 102 based on declined transaction history for a transaction account used in a proposed payment transaction. The receiving device 202 may also be configured to receive data signals electronically transmitted by nodes 112 in a blockchain network 110, which may be superimposed or otherwise encoded with blockchain data, wherein the blockchain data may include data values included in blocks that correspond to declined payment transactions.

The point of sale device 102 may also include a communication module 204. The communication module 204 may be configured to transmit data between modules, engines, databases, memories, and other components of the point of sale device 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the point of sale device 102 and external components of the point of sale device 102, such as externally connected databases, display devices, input devices, etc. The point of sale device 102 may also include a processing device. The processing device may be configured to perform the functions of the point of sale device 102 discussed herein as will be apparent to persons having skill in the relevant art. In some embodiments, the processing device may include and/or be comprised of a plurality of engines and/or modules specially configured to perform one or more functions of the processing device, such as a querying module 214, determination module 216, generation module 218, etc. As used herein, the term “module” may be software or hardware particularly programmed to receive an input, perform one or more processes using the input, and provides an output. The input, output, and processes performed by various modules will be apparent to one skilled in the art based upon the present disclosure.

The point of sale device 102 may also include a memory 224. The memory 224 may be configured to store data for use by the point of sale device 102 in performing the functions discussed herein, such as public and private keys, symmetric keys, etc. The memory 224 may be configured to store data using suitable data formatting methods and schema and may be any suitable type of memory, such as read-only memory, random access memory, etc. The memory 224 may include, for example, encryption keys and algorithms, communication protocols and standards, data formatting standards and protocols, program code for modules and application programs of the processing device, and other data that may be suitable for use by the point of sale device 102 in the performance of the functions disclosed herein as will be apparent to persons having skill in the relevant art. In some embodiments, the memory 224 may be comprised of or may otherwise include a relational database that utilizes structured query language for the storage, identification, modifying, updating, accessing, etc. of structured data sets stored therein. The memory 224 may be configured to store, for example, transaction details for a proposed payment transaction, blockchain data received from nodes 112, fraud algorithms, fraud score thresholds, hashing algorithms for generating account identifiers, communication data for issuing institutions 108 or fraud determiners 114, etc. The memory 224 may also store any additional data for use by the point of sale device 102 in performing any traditional functions of a point of sale device 102 such as for the processing of traditional payment transactions.

The point of sale device 102 may include a querying module 214. The querying module 214 may be configured to execute queries on databases to identify information. The querying module 214 may receive one or more data values or query strings, and may execute a query string based thereon on an indicated database, such as the memory 224, to identify information stored therein. The querying module 214 may then output the identified information to an appropriate engine or module of the point of sale device 102 as necessary. The querying module 214 may, for example, execute a query on the memory 224 to identify a fraud algorithm to be used to determine if a proposed payment transaction should be declined based on a history of declined payment transactions identified in blockchain data, which may also be identified via execution of one or more queries on the memory 224.

The point of sale device 102 may also include a determination module 216. The determination module 216 may be configured to make determinations for the point of sale device 102 for use in performing the functions discussed herein. The determination module 216 may receive instructions as input, may make a determination as requested in the instructions, and may output a result of the determination to another module or engine of the point of sale device 102. In some instances, the instructions may include data for use by the determination module 216 (e.g., declined transaction history and proposed payment transaction details). In other instances, the determination module 216 may be configured to identify data for use in the determinations, such as by instructing the querying module 214 to execute queries on the memory 224 to identify such information. The determination module 216 may be configured to determine if a proposed payment transaction is to be declined based on transaction details for the proposed payment transaction and declined transaction history for the transaction account as obtained from the blockchain. In some cases, the determination may use issuing institution-specific fraud algorithms. In some instances, the determination module 216 may generate a fraud score, which may be compared with a score threshold to determine if the proposed payment transaction should be declined.

The point of sale device 102 may also include a generation module 218. The generation module 218 may be configured to generate data and/or data messages for use by the point of sale device 102 in performing the functions discussed herein. The generation module 218 may receive instructions as input, may make a determination as requested in the instructions, and may output a result of the determination to another module or engine of the point of sale device 102. In some instances, the instructions may include data for use by the generation module 218 (e.g., transaction details for a proposed payment transaction). In other instances, the generation module 218 may be configured to identify data for use in the determinations, such as by instructing the querying module 214 to execute queries on the memory 224 to identify such information. The generation module 218 may, for instance, generate data messages that include proposed transaction details and/or declined transaction history for transmission to issuing institutions 108 and/or fraud determiners 114, data messages for transmission to payment networks that include transaction details for the proposed payment transaction for processing thereby, data messages that include transaction details for a declined payment transaction for transmission to a node 112 for inclusion in the blockchain.

The point of sale device 102 may also include a transmitting device 222. The transmitting device 222 may be configured to transmit data over one or more networks via one or more network protocols. In some instances, the transmitting device 222 may be configured to transmit data to issuing institutions 108, nodes 112, fraud determiners 114, and other entities via one or more communication methods, local area networks, wireless area networks, cellular communication, Bluetooth, radio frequency, the Internet, etc. In some embodiments, the transmitting device 222 may be comprised of multiple devices, such as different transmitting devices for transmitting data over different networks, such as a first transmitting device for transmitting data over a local area network and a second transmitting device for transmitting data via the Internet. The transmitting device 222 may electronically transmit data signals that have data superimposed that may be parsed by a receiving computing device. In some instances, the transmitting device 222 may include one or more modules for superimposing, encoding, or otherwise formatting data into data signals suitable for transmission.

The transmitting device 222 may be configured to electronically transmit data signals superimposed or otherwise encoded with proposed transaction details and, if applicable, declined transaction history, to issuing institutions 108 and fraud determiners 114 for use in determining if a proposed payment transaction is to be declined. The transmitting device 222 may also be configured to electronically transmit data signals to nodes 112, which may be superimposed or otherwise encoded with requests for blockchain data or transaction details for a declined payment transaction for inclusion in a new block as a data value for addition to the blockchain and use in future determinations by the point of sale device 102.

### Process for Declining Payment Transactions Based on Fraud Determinations

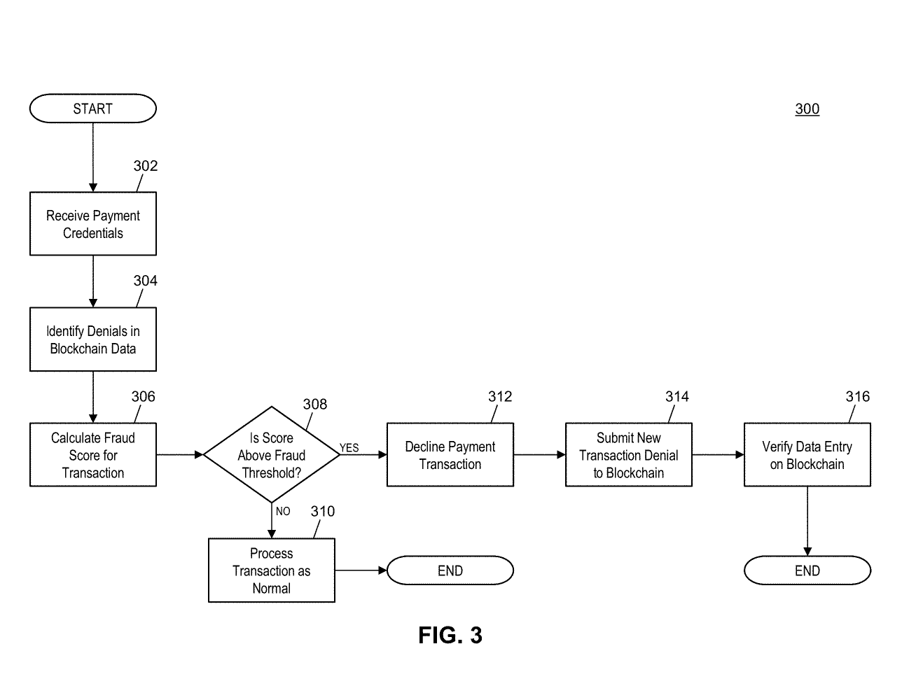

FIG. 3 illustrates a process executed by the point of sale device 102 for the declining of a proposed payment transaction based on a history of declined payment transactions associated with the same transaction account identified via a blockchain.

In step 302, the receiving device 202 of the point of sale device 102 may receive payment credentials from a payment instrument 106 for use in a proposed payment transaction. The payment credentials may include an account identifier, or other data that may be used (e.g., by the generation module 218 or querying module 214 of the point of sale device 102) to identify an account identifier, such as a primary account number that may be hashed to generate an account identifier. The payment credentials may be received from the payment instrument 106 using any suitable method, such as by reading a magnetic stripe encoded with payment credentials, receiving the payment credentials from an integrated circuit via physical contact or near field communication, etc.

In step 304, the querying module 214 of the point of sale device 102 may execute a query on the memory 224 of the point of sale device 102 to identify data values stored in the blockchain associated with the blockchain network 110 that is stored therein that correspond to declined payment transactions involving the transaction account associated with the payment instrument 106, using the account identifier. In step 306, the determination module 216 of the processing server 102 may calculate a fraud score for the proposed payment transaction. The fraud score may be based on transaction details for the proposed payment transaction (e.g., stored in the memory 224 and queried therefrom by the querying module 214) and the data included in each of the data values identified for past declined payment transactions. In some embodiments, the fraud score may be calculated using an algorithm provided by the issuing institution 108 that issued the payment instrument 106, which may be identified by the account identifier or other payment credentials or data received from the payment instrument 106.

In step 308, the determination module 216 of the point of sale device 102 may determine if the calculate fraud score is above a fraud threshold. In some cases, the fraud threshold may be specific to the issuing institution 108 and, in some instances, may be specific to the transaction account associated with the payment instrument 106. In such cases, the fraud threshold may be stored in the memory 224 of the point of sale device 102 or obtained from the issuing institution 108 during the process 300. If the calculated fraud score is not above the fraud threshold, then the proposed payment transaction may not be immediately determined as likely fraudulent, and, in step 310, the point of sale device 102 may proceed with the payment transaction as normal. In such an instance, the generation module 218 may generate a transaction message for the proposed payment transaction that includes the transaction details and payment credentials, which may be submitted to a payment network (e.g., directly or via one or more intermediate entities) for processing using traditional methods.

If, in step 308, the determination module 216 determines that the fraud score calculated for the proposed payment transaction exceeds the fraud threshold, then, in step 312, the point of sale device 102 may decline the payment transaction. The point of sale device 102 may perform any traditional functions of a point of sale for a declined payment transaction, such as by displaying a message to the consumer 104 and canceling the proposed payment transaction. In step 314, the transmitting device 222 of the point of sale device 102 may electronically transmit a data signal to a node 112 in the blockchain network 110 that is superimposed or otherwise encoded with transaction details for the declined payment transaction. The transaction details may include at least the account identifier, a timestamp, and a point of sale identifier associated with the point of sale device 102. In some cases, the transaction details may also include a reason code (e.g., declined due to likelihood of fraud), merchant identifier associated with the merchant for which the point of sale device 102 operates, geographic location of the point of sale device 102, or any other data that may be used in future fraud determinations. In step 316, the point of sale device 102 may verify that a new data value was stored in the blockchain corresponding to the declined payment transaction, such as by identifying a data value in a newly added block that includes the same transaction details as submitted to the node 112 in step 314.

### Exemplary Method for Determining Fraud for a Transaction via Blockchain

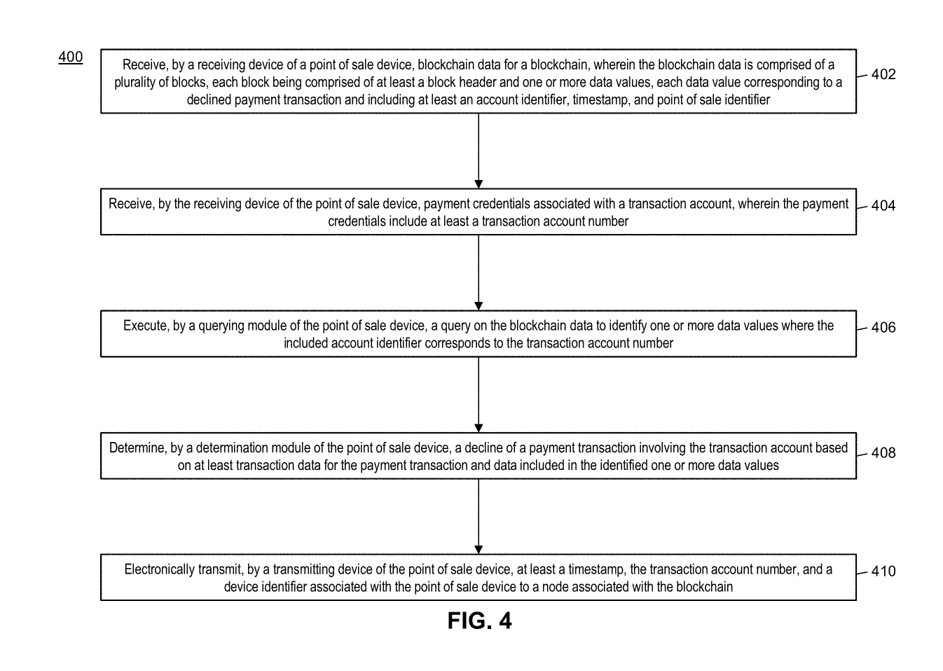

FIG. 4 illustrates a method 400 for the determining of fraud in a proposed payment transaction based on a history of declined payment transactions for the same transaction account as identified in a blockchain.

In step 402, blockchain data for a blockchain may be received by a receiving device (e.g., the receiving device 202) of a point of sale device (e.g., the point of sale device 102), wherein the blockchain data is comprised of a plurality of blocks, each block being comprised of at least a block header and one or more data values, each data value corresponding to a declined payment transaction and including at least an account identifier, timestamp, and point of sale identifier. In step 404, payment credentials associated with a transaction account may be received by the receiving device of the point of sale device, wherein the payment credentials include at least a transaction account number. In step 406, a query may be executed on the blockchain data by a querying module (e.g., the querying module 214) of the point of sale device to identify one or more data values where the included account identifier corresponds to the transaction account number.

In step 408, a decline of the payment transaction involving the transaction account may be determined by a determination module (e.g., the determination module 216) of the point of sale device based on at least transaction data for the payment transaction and data included in the identified one or more data values. In step 410, at least a timestamp, the transaction account number, and a device identifier associated with the point of sale device may be electronically transmitted by a transmitting device (e.g., the transmitting device 222) of the point of sale device to a node (e.g., node 112) associated with the blockchain.

In one embodiment, the method 400 may further include storing, in a memory (e.g., the memory 224) of the point of sale device, at least the device identifier and the transaction data for the payment transaction. In a further embodiment, the transaction data for the payment transaction may include at least the timestamp and a transaction amount. In some embodiments, each data value may further includes a geographic location associated with the corresponding declined payment transaction, the decline of the payment transaction may be further based on a geographic location associated with the point of sale device, and the electronic transmission to the node may further include the geographic location associated with the point of sale device.

In one embodiment, determining the decline of the payment transaction may include calculating, by the determination module of the point of sale device, a fraud score for the payment transaction based on at least the transaction data for the payment transaction and the data included in the identified one or more data values using at least one fraud algorithm, and the fraud score may exceed a threshold score. In a further embodiment, the method 400 may also include storing, in a memory of the point of sale device, the at least one fraud algorithm and the threshold score. In some embodiments, determining the decline of the payment transaction may include: electronically transmitting, by the transmitting device of the point of sale device, at least the transaction data for the payment transaction and the data included in the identified one or more data values to an external computing system; and receiving, by the receiving device of the point of sale device, a fraud determination from the external computing system. In a further embodiment, the fraud determination may be a fraud score for the payment transaction, and the fraud score may exceed a threshold score.

### Computer System Architecture

FIG. 5 illustrates a computer system 500 in which embodiments of the present disclosure, or portions thereof, may be implemented as computer-readable code. For example, the point of sale device 102 of FIG. 1 may be implemented in the computer system 500 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3 and 4.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose or a general purpose processor device specifically configured to perform the functions discussed herein. The processor device 504 may be connected to a communications infrastructure 506, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 may also include a main memory 508 (e.g., random access memory, read-only memory, etc.), and may also include a secondary memory 510. The secondary memory 510 may include the hard disk drive 512 and a removable storage drive 514, such as a floppy disk drive, a magnetic tape drive, an optical disk drive, a flash memory, etc.

The removable storage drive 514 may read from and/or write to the removable storage unit 518 in a well-known manner. The removable storage unit 518 may include a removable storage media that may be read by and written to by the removable storage drive 514. For example, if the removable storage drive 514 is a floppy disk drive or universal serial bus port, the removable storage unit 518 may be a floppy disk or portable flash drive, respectively. In one embodiment, the removable storage unit 518 may be non-transitory computer readable recording media.

In some embodiments, the secondary memory 510 may include alternative means for allowing computer programs or other instructions to be loaded into the computer system 500, for example, the removable storage unit 522 and an interface 520. Examples of such means may include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 500 may also include a communications interface 524. The communications interface 524 may be configured to allow software and data to be transferred between the computer system 500 and external devices. Exemplary communications interfaces 524 may include a modem, a network interface (e.g., an Ethernet card), a communications port, a PCMCIA slot and card, etc. Software and data transferred via the communications interface 524 may be in the form of signals, which may be electronic, electromagnetic, optical, or other signals as will be apparent to persons having skill in the relevant art. The signals may travel via a communications path 526, which may be configured to carry the signals and may be implemented using wire, cable, fiber optics, a phone line, a cellular phone link, a radio frequency link, etc.

The computer system 500 may further include a display interface 502. The display interface 502 may be configured to allow data to be transferred between the computer system 500 and external display 530. Exemplary display interfaces 502 may include high-definition multimedia interface (HDMI), digital visual interface (DVI), video graphics array (VGA), etc. The display 530 may be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 508 and secondary memory 510, which may be memory semiconductors (e.g., DRAMs, etc.). These computer program products may be means for providing software to the computer system 500. Computer programs (e.g., computer control logic) may be stored in the main memory 508 and/or the secondary memory 510. Computer programs may also be received via the communications interface 524. Such computer programs, when executed, may enable computer system 500 to implement the present methods as discussed herein. In particular, the computer programs, when executed, may enable processor device 504 to implement the methods illustrated by FIGS. 3 and 4, as discussed herein. Accordingly, such computer programs may represent controllers of the computer system 500. Where the present disclosure is implemented using software, the software may be stored in a computer program product and loaded into the computer system 500 using the removable storage drive 514, interface 520, and hard disk drive 512, or communications interface 524.

The processor device 504 may comprise one or more modules or engines configured to perform the functions of the computer system 500. Each of the modules or engines may be implemented using hardware and, in some instances, may also utilize software, such as corresponding to program code and/or programs stored in the main memory 508 or secondary memory 510. In such instances, program code may be compiled by the processor device 504 (e.g., by a compiling module or engine) prior to execution by the hardware of the computer system 500. For example, the program code may be source code written in a programming language that is translated into a lower level language, such as assembly language or machine code, for execution by the processor device 504 and/or any additional hardware components of the computer system 500. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for determining fraud for a transaction via blockchain. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for determining fraud for a transaction via blockchain, comprising:
receiving, by a receiving device of a point of sale device, blockchain data for a blockchain, wherein the blockchain data is comprised of a plurality of blocks, each block being comprised of at least a block header and one or more data values, each data value corresponding to a declined payment transaction and including at least an account identifier, timestamp, and point of sale identifier;
receiving, by the receiving device of the point of sale device, payment credentials associated with a transaction account, wherein the payment credentials include at least a transaction account number;
executing, by a querying module of the point of sale device, a query on the blockchain data to identify one or more data values where the included account identifier corresponds to the transaction account number;
determining, by a determination module of the point of sale device, a decline of a payment transaction involving the transaction account based on at least transaction data for the payment transaction and data included in the identified one or more data values; and
electronically transmitting, by a transmitting device of the point of sale device, at least a timestamp, the transaction account number, and a device identifier associated with the point of sale device to a node associated with the blockchain.

2. The method of claim 1, further comprising:
storing, in a memory of the point of sale device, at least the device identifier and the transaction data for the payment transaction.

3. The method of claim 2, wherein the transaction data for the payment transaction includes at least the timestamp and a transaction amount.

4. The method of claim 1, wherein
each data value further includes a geographic location associated with the corresponding declined payment transaction,
the decline of the payment transaction is further based on a geographic location associated with the point of sale device, and
the electronic transmission to the node further includes the geographic location associated with the point of sale device.

5. The method of claim 1, wherein
determining the decline of the payment transaction includes calculating, by the determination module of the point of sale device, a fraud score for the payment transaction based on at least the transaction data for the payment transaction and the data included in the identified one or more data values using at least one fraud algorithm, and
the fraud score exceeds a threshold score.

6. The method of claim 5, further comprising:
storing, in a memory of the point of sale device, the at least one fraud algorithm and the threshold score.

7. The method of claim 1, wherein determining the decline of the payment transaction includes:
electronically transmitting, by the transmitting device of the point of sale device, at least the transaction data for the payment transaction and the data included in the identified one or more data values to an external computing system; and
receiving, by the receiving device of the point of sale device, a fraud determination from the external computing system.

8. The method of claim 7, wherein
the fraud determination is a fraud score for the payment transaction, and
the fraud score exceeds a threshold score.

9. A system for determining fraud for a transaction via blockchain, comprising:
a receiving device of a point of sale device configured to
receive blockchain data for a blockchain, wherein the blockchain data is comprised of a plurality of blocks, each block being comprised of at least a block header and one or more data values, each data value corresponding to a declined payment transaction and including at least an account identifier, timestamp, and point of sale identifier, and
receive payment credentials associated with a transaction account, wherein the payment credentials include at least a transaction account number;
a querying module of the point of sale device configured to execute a query on the blockchain data to identify one or more data values where the included account identifier corresponds to the transaction account number;
a determination module of the point of sale device configured to determine a decline of a payment transaction involving the transaction account based on at least transaction data for the payment transaction and data included in the identified one or more data values; and
a transmitting device of the point of sale device configured to electronically transmit at least a timestamp, the transaction account number, and a device identifier associated with the point of sale device to a node associated with the blockchain.

10. The system of claim 9, further comprising:
a memory of the point of sale device configured to store at least the device identifier and the transaction data for the payment transaction.

11. The system of claim 10, wherein the transaction data for the payment transaction includes at least the timestamp and a transaction amount.

12. The system of claim 9, wherein
each data value further includes a geographic location associated with the corresponding declined payment transaction,
the decline of the payment transaction is further based on a geographic location associated with the point of sale device, and
the electronic transmission to the node further includes the geographic location associated with the point of sale device.

13. The system of claim 9, wherein
determining the decline of the payment transaction includes calculating, by the determination module of the point of sale device, a fraud score for the payment transaction based on at least the transaction data for the payment transaction and the data included in the identified one or more data values using at least one fraud algorithm, and
the fraud score exceeds a threshold score.

14. The system of claim 13, further comprising:
a memory of the point of sale device configured to store the at least one fraud algorithm and the threshold score.

15. The system of claim 9, wherein determining the decline of the payment transaction includes:
electronically transmitting, by the transmitting device of the point of sale device, at least the transaction data for the payment transaction and the data included in the identified one or more data values to an external computing system; and
receiving, by the receiving device of the point of sale device, a fraud determination from the external computing system.

16. The system of claim 15, wherein
the fraud determination is a fraud score for the payment transaction, and
the fraud score exceeds a threshold score.
